(19) United States
(12) Patent Application Publication
(10) Pub. No.: US 2017/0047167 A1
(43) Pub. Date: Feb. 16, 2017

(54) METHOD AND APPARATUS FOR FOLDED, ROUGH, AND/OR FRACTAL CAPACITORS

(71) Applicant: FRACTAL ANTENNA SYSTEMS, INC., Bedford, MA (US)

(72) Inventors: Nathan COHEN, Belmont, MA (US); Philip SALKIND, Boston, MA (US)

(21) Appl. No.: 15/340,440

(22) Filed: Nov. 1, 2016

Related U.S. Application Data
(63) Continuation of application No. PCT/US15/61704, filed on Nov. 19, 2015.
(60) Provisional application No. 62/123,580, filed on Nov. 20, 2014.

(51) Int. Cl. H01G 4/33; H01G 4/01; H01G 4/018

(52) U.S. Cl. CPC H01G 4/33; H01G 4/018; H01G 4/01

(57) ABSTRACT

Novel capacitors that have volumetric components that incorporate one or more folds and/or bends and/or have self-similar structures are disclosed. The components may have surfaces that are fractal in finite iterations for at least a portion of the component; moreover, the components (e.g., opposing capacitive elements) may be self-complementary to one another such that one component is self-complementary to another component in a given capacitor. Methods of using 3D printers to make such capacitors and capacitive components are also described.

### CROSS-REFERENCE TO RELATED APPLICATIONS

This application is a continuation of International Application No. PCT/US2015/061704, filed Nov. 19, 2015; filed in the United States Receiving Office, which claims the benefit of, and priority to, U.S. Provisional Application No. 62/123,580 filed Nov. 20, 2014; the entire contents of both applications are incorporated herein by reference.

### BACKGROUND

Capacitors are fundamental electrical components requiring two plates with a dielectric separation. This has been accomplished through standard methods invoking separation of two conductors with a dielectric substrate in between. The techniques to make these do not allow for complex shapes, such as fractals or folds, to be used and thus limit possibilities. What is needed is a new means for producing capacitors which allows for easy manufacturing of complex shaped ‘plates’ and dielectrics.

### SUMMARY

An aspect of the present disclosure is directed to folded, rough, and/or fractal capacitors, as well as systems capable of producing these kinds of capacitors. Such capacitors can have volumetric components or elements that incorporate one or more folds and/or bends and/or have self-similar structure (fractal in finite iterations for at least a portion) for at least part of the component; moreover, the components (e.g., opposing capacitive elements) may be self-complementary to one another such that one component is self-complementary to another component in a given capacitor.

In some embodiments, a system can use a three dimensional printer to make volumetric components that incorporate one or more folds and/or bends and/or have self-similar structure (fractal in finite iterations for at least a portion) for at least part of the component. The component may be constructed out of conductive plastic, or non-conductive plastic or other non-conductive material. Alternatively the system uses a three dimensional printer to make volumetric metal or metal coated components that incorporate one or more folds and/or have self-similar structure (fractal in finite iterations for at least a portion) for at least part of the component.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps

FIG. 1 shows an example of capacitive elements for a fractal capacitor according to the present disclosure.

FIGS. 2A and 2B include views which show alternative embodiments of capacitive elements according to the present disclosure.

FIG. 3 shows steps in a method of making a fractal capacitor according to the present disclosure.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

An aspect of the present disclosure is directed to novel capacitors that have volumetric components that incorporate one or more folds and/or bends and/or have self-similar structure (fractal in finite iterations for at least a portion) for at least part of the component; moreover, the components (e.g., opposing capacitive elements) may be self-complementary to one another such that one component is self-complementary to another component in a given capacitor. The components may be constructed out of conductive plastic, or non-conductive plastic or other non-conductive material. Alternatively the components may be made of metal or metal coated components that incorporate one or more folds and/or have self-similar structure (fractal in finite iterations for at least a portion) for at least part of the component. The components can have a volumetric of 3D characteristic. The components may be made by any suitable means, but as described below, exemplary embodiments use 3D printers to make such components.

The capacitor dielectric may be air or some other suitable material, either liquid, gas, or vacuum or solid. If non-conductive material is used, the component may be plated or gilded with a conductor (such as conductive paint) after printing so the component then conducts and can act as an electromagnetic component. Alternatively, the component may only be partially plated and the non-conductive material will act as a dielectric. The component(s) may have smaller size or higher capacitance for the same volume.

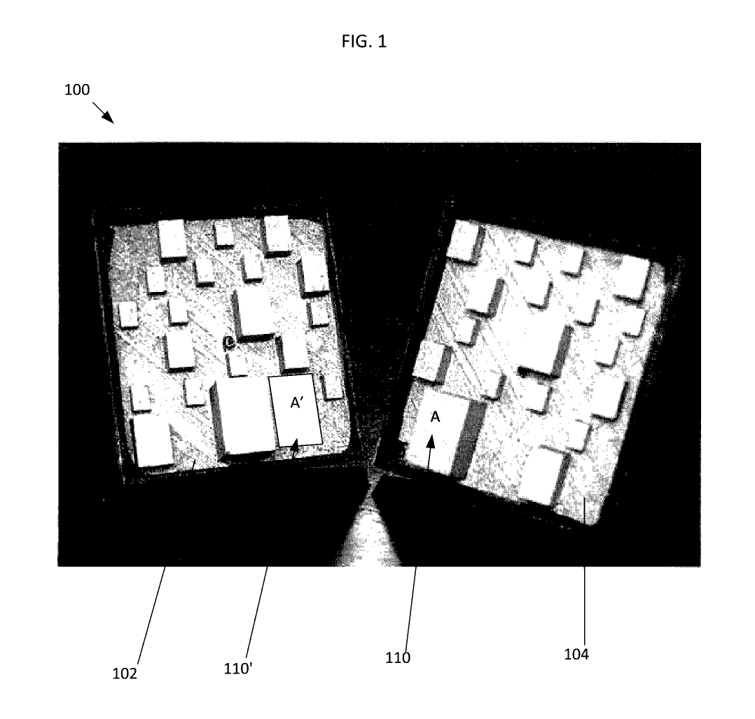

FIG. 1 shows an example 100 of capacitive elements 102, 104 for use in a fractal capacitor according to the present disclosure. Surface features 110 and 110′ are indicated, and these surface features are replicated at different scales over the surface of each of the components. Note that components 102 and 104 are substantially self-complementary, as shown by element 110 (A) of element 104 being self-complementary to region 110′ (A′) of element 102. Thus, elements 102 and 104 can form nesting plates of a capacitor. In exemplary embodiments, elements 102 and 104 may be printed by use of a 3D printer, and painted with conductive paint as shown. Any suitable dielectric material, e.g., air, may be used for such a capacitor.

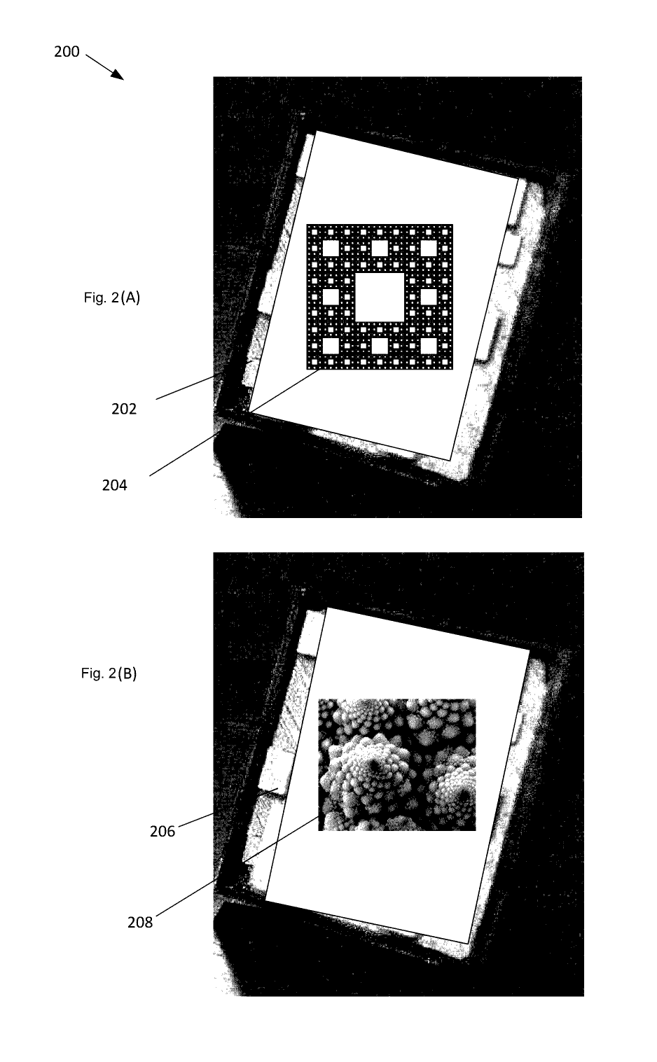

FIG. 2 shows a set 200 of alternate embodiments (in A and B) of volumetric (or, 3D) capacitive elements 202 and 206 that may be used within the scope of the present disclosure. As was noted previously, and as shown in (A), capacitive elements according to the present disclosure can have fractal features and/or surfaces. Capacitive element 202 includes a surface 204 having a Sierpinksi carpet feature, which may also be characterized as a Menger sponge (the latter name indicated a greater degree of vertical relief or height). When used in a capacitor according to the present invention, the mating (or opposed) capacitive element (to 202) may have a surface that is (i) complementary to surface 204, (ii) a mirror image or substantially a mirror image to surface 204, (iii) a fractal surface that is different than 204, (iv) a simple flat surface, and/or (v) any combination of (i)-(iv).

With continued reference to FIG. 2, view (B) shows another capacitive element 206 with a surface 208 exhibiting a topography with a logarithmic spiral based pattern, as shown, similar to Romansco broccoli. Such a pattern is a natural representation of the Fibonacci or golden spiral, a logarithmic spiral where every quarter turn is farther from the origin by a factor of phi, the golden ratio. As was noted for view (A), when used in a capacitor according to the present invention, the mating (or opposed) capacitive element (to 208) may have a surface that is (i) complementary to surface 208, (ii) a mirror image or substantially a mirror image to surface 208, (iii) a fractal surface that is different than 208, (iv) a simple flat surface, and/or (v) any combination of (i)-(iv). Such capacitive elements may have surfaces that also incorporate folds or pleats in addition to the features already described.

A further aspect of the present disclosure is directed to novel systems capable of producing capacitive elements as described herein. The systems can utilize uses a three dimensional printer to make volumetric components for capacitors that incorporate one or more folds and/or bends and/or have self-similar structure (fractal in finite iterations for at least a portion) for at least part of the component. The component may be constructed out of conductive plastic, or non-conductive plastic or other non-conductive material. Such 3D printers can produce volumetric metal or metal coated capacitive elements (capacitive components) that incorporate one or more folds and/or have self-similar structure (fractal in finite iterations for at least a portion) for at least part of the component.

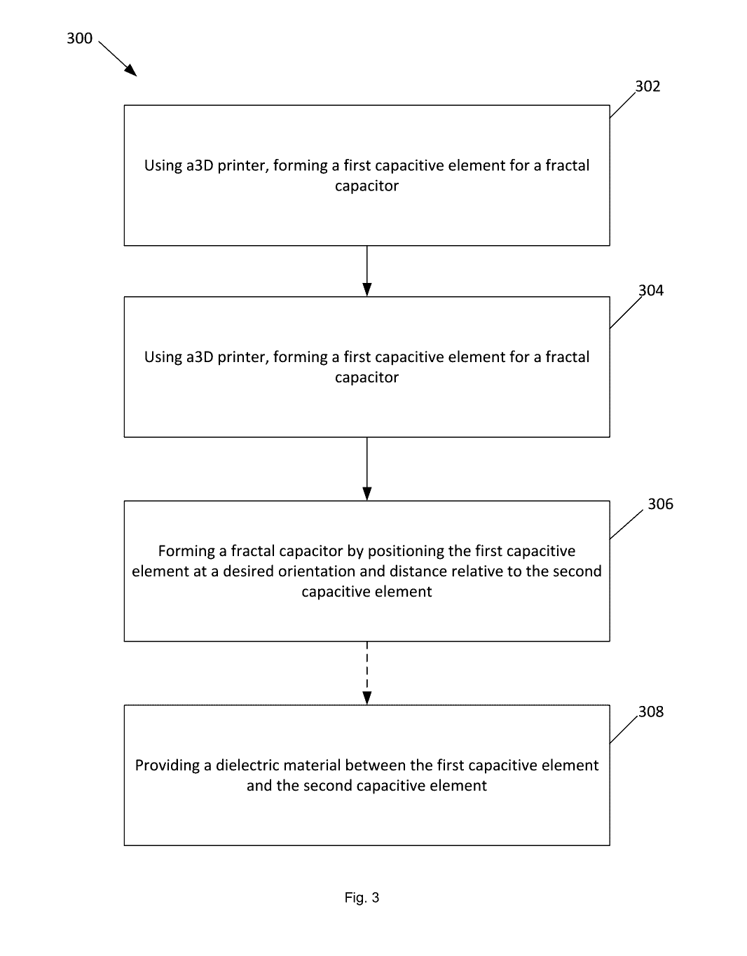

FIG. 3 shows steps in a method 300 of making capacitors in accordance with the present disclosure. An example of a suitable 3D printer is a MakerBot Replicator Z18 3D printer made available by the MakerBot Industries LLC. As shown at step 302, a 3D printer may be used to print or form a first capacitive element (e.g., similar to 102 of FIG. 1). In some embodiments, such a 3D printer may make the capacitive element by printing the element using non-conductive plastic. The element may subsequently be coated or plated with a conductive material, e.g., conductive paint or plating material. As shown at step 304, a 3D printer may be used to print or form a second capacitive element (e.g., similar to 104 of FIG. 1).

Continuing with the description of manufacturing/fabrication method 300, a fractal capacitor may be formed by positioning the first capacitive element at a desired orientation and distance relative to the second capacitive element, as shown at 306. In some embodiments, this step may include aligning the rectangular edges of the two facing capacitive elements (e.g., 102 and 104 of FIG. 1). Method 300 can also include a step of providing a dielectric material between the first capacitive element and the second capacitive element.

For 3D printing of components described herein, non-conductive material can be used. Components printed using such materials may be plated or gilded with a conductor (such as conductive paint) after printing so the component then conducts and can act as an electromagnetic component, e.g., a fractal capacitive element or plate. Alternatively, the component may not be plated (or coated), or only partially plated (or coated) and the non-conductive material will act as a dielectric.

While air was described previously as being a dielectric material suitable for capacitors according to the present disclosure, other types of dielectric materials may be used within the scope of the present disclosure. Suitable examples include but are not limited to: ceramic dielectrics, e.g., lead zirconate titanate (PZT) ferroelectric ceramic; combination films, e.g., a combination of polyester (Mylar) and polypropylene; glasses; Kapton film: KF (polymer) film; mica, including plain mica, metallized mica, and silver mica are more resistant to moisture; and, paper film, to name but a few. Other suitable dielectrics may be used.

### Exemplary Embodiments

The following are exemplary embodiments of the present disclosure:

A fractal capacitor including:
a first capacitive element having a surface including a first self-similar structure for at least part of the element;
a second capacitive element having a surface including a second self-similar structure for at least part of the element; and
a dielectric material disposed between the first and second capacitive elements.

The first self-similar structure can include one or more folds.

The first self-similar structure can include one or more bends.

The first self-similar structure can include a first fractal feature.

The capacitor first fractal feature can include a pattern of rectangular prisms (e.g., as shown in FIG. 1) repeated at multiple different scales (e.g., as shown in FIG. 1).

The first fractal feature can include a Sierpinski carpet (or mesh or gasket).

The first fractal feature can include a Menger sponge.

The first fractal feature can include a logarithmic spiral based pattern (e.g., as or similar to that shown in FIG. 2).

The second self-similar structure can include a second fractal feature.

The second fractal feature can include a pattern of rectangular prisms (e.g., as shown in FIG. 1)repeated at multiple different scales (e.g., as shown in FIG. 1).

The second fractal feature can include a Sierpinski carpet.

The second fractal feature can include a Menger sponge.

The second fractal feature comprises a logarithmic spiral based pattern (e.g., as shown in FIG. 2).

The respective surfaces of the first and second capacitive elements can be self-complementary (e.g., as shown in FIG. 1).

Unless otherwise indicated, the design and/or manufacture/fabrication of the capacitors and capacitive elements that have been discussed herein may be implemented with a computer system configured to perform the functions that have been described herein for the component. Each computer system includes one or more processors, tangible memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

Each computer system for the he design and/or manufacture/fabrication of the capacitors and capacitive elements may be a desktop computer or a portable computer, such as a laptop computer, a notebook computer, a tablet computer, a PDA, a smartphone, or part of a larger system, such a vehicle, appliance, and/or telephone system.

A single computer system may be shared by users/designers for the he design and/or manufacture/fabrication of the capacitors and capacitive elements.

Each computer system for the he design and/or manufacture/fabrication of the capacitors and capacitive elements may include one or more computers at the same or different locations. When at different locations, the computers may be configured to communicate with one another through a wired and/or wireless network communication system.

Each computer system may include software (e.g., one or more operating systems, device drivers, application programs, and/or communication programs). When software is included, the software includes programming instructions and may include associated data and libraries. When included, the programming instructions are configured to implement one or more algorithms that implement one or more of the functions of the computer system, as recited herein. The description of each function that is performed by each computer system also constitutes a description of the algorithm(s) that performs that function.

The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and/or advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims. [0050]The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A fractal capacitor comprising:
a first capacitive element having a surface including a first self-similar structure for at least part of the element, wherein the first self-similar structure includes a first fractal feature, and wherein the first self-similar structure includes a surface with one or more folds;
a second capacitive element having a surface including a second self-similar structure for at least part of the element, wherein the second self-similar structure includes a second fractal feature; and
a dielectric material disposed between the first and second capacitive elements; and
wherein the first self-similar structure and the second self-similar structure are each self-complementary.

2. The capacitor of claim 1, wherein the first self-similar structure includes one or more bends.

3. The capacitor of claim 1, wherein the first fractal feature comprises a pattern of rectangular prisms repeated at multiple different scales.

4. The capacitor of claim 1, wherein the first fractal feature comprises a Sierpinski carpet.

5. The capacitor of claim 1, wherein the first fractal feature comprises a Menger sponge.

6. The capacitor of claim 1, wherein the first fractal feature comprises a logarithmic spiral based pattern.

7. The capacitor of claim 1, wherein the second fractal feature comprises a pattern of rectangular prisms repeated at multiple different scales.

8. The capacitor of claim 1, wherein the second fractal feature comprises a Sierpinski carpet.

9. The capacitor of claim 1, wherein the second fractal feature comprises a Menger sponge.

10. The capacitor of claim 1, wherein the second fractal feature comprises a logarithmic spiral based pattern.
